(19) United States
(12) Patent Application Publication
(10) Pub. No.: US 2020/0210957 A1
(43) Pub. Date: Jul. 2, 2020

(54) CLASSIFICATION OF JOB TITLES VIA MACHINE LEARNING

(71) Applicant: CareerBuilder, LLC, Chicago, IL (US)

(72) Inventors: Brian Gaspar, Los Gatos, CA (US); Mohammed Korayem, Johns Creek, GA (US); Jingya Wang, Duluth, GA (US); Kareem Abdelfatah, Alpharetta, GA (US); Janani Balaji, Cumming, GA (US); Robert Malony, Daytona Beach, FL (US); Eric Presely, Peachtree Corners, GA (US); Humair Ghauri, San Ramon, CA (US)

(21) Appl. No.: 16/383,019

(22) Filed: Apr. 12, 2019

Related U.S. Application Data
(60) Provisional application No. 62/786,880, filed on Dec. 31, 2018.

(51) Int. Cl. G06Q 10/10; G06N 3/08

(52) U.S. Cl. CPC G06Q 10/1053; G06N 3/08

(57) ABSTRACT

Method and apparatus are disclosed for classification of job titles via machine learning. An example system includes memory configured to store a convolutional neural network (CNN). The CNN includes a character-title partial-CNN, a word-title partial-CNN, a description CNN, and at least one fully-connected layer. The example system also includes one or more processors configured to apply the character-title partial-CNN to a title to generate a character-level feature, apply the word-title partial-CNN to the title to generate a first word-level feature, and apply the description partial-CNN to a description to generate a second word-level feature. The one or more processors are configured to generate a posting feature by concatenating the character-level feature, the first word-level feature, and the second word-level feature. The one or more processors are configured to determine a numeric representation of a classification for the title by applying the at least one fully-connected layer to the posting feature.

### CROSS-REFERENCE TO RELATED APPLICATION

This application claims the benefit of U.S. Provisional Applicant No. 62/786,880, filed on Dec. 31, 2018, which is incorporated by reference in its entirety.

### TECHNICAL FIELD

The present disclosure generally relates to job title classifications and, more specifically, to classification of job titles via machine learning.

### BACKGROUND

Employment websites (CareerBuilder.com®) generally are utilized to facilitate employers in hiring job seekers for open positions. Oftentimes, an employment website incorporates a job board on which employers may post the open positions they are seeking to fill. In some instances, the job board enables an employer to include duties of the posted position and/or desired or required qualifications of job seekers for the posted position.

Some employment websites enable a job seeker to search through positions posted on the job board. If the job seeker identifies a position of interest, the employment website may provide an application to the job seeker and/or enable the job seeker to submit a completed application, a resume, and/or a cover letter to the employer. Some employment websites may include thousands of job postings for a particular location and/or field of employment, thereby making it difficult for a job seeker to find positions of interest. Further, some job seekers may have difficulty identifying which of his or her qualifications (e.g., education, work experience, occupational licenses, etc.) are attractive to different employers. In an attempt to avert those job seekers from being overwhelmed by the job seeking process, some employment websites generate recommended positions to a job seeker based on his or her qualifications and/or desires. Because of the large number of participating employers, some employment websites may potentially have difficulty in generating a useful list of recommendations for a job seeker.

Further, some employment websites include tens of thousands of job seekers that may be seeking employment in a particular region. In some instances, some of those job seekers may submit applications and/or resumes to positions for which they are unqualified (e.g., a retail cashier applying for a position as a CEO). Thus, an employer may be inundated with applications and/or resumes submitted by (qualified and unqualified) job seekers. As a result, employers potentially may find it difficult to identify job seekers qualified for their posted position. In an attempt to avert those employers from being overwhelmed by applications of unqualified job seekers, some employment websites allow employers to search for potential job seekers of interest. For instance, some employment websites may generate a list of job seekers for an employer based on desired qualifications and/or skills identified by an employer. Because of the large number of job seekers, some employment websites may potentially have difficulty in generating a useful list of potential job seekers for an employer.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for classification of job titles via machine learning. An example disclosed system for automatically classifying employment titles of employment postings includes memory configured to store a convolutional neural network (CNN). The CNN includes a character-title partial-CNN, a word-title partial-CNN, a description CNN, and at least one fully-connected layer. The example disclosed system also includes one or more processors configured to collect an employment posting, extract text of the employment posting, identify a title and a description within the extracted text, apply the character-title partial-CNN to the title to generate a character-level feature based on characters within the title, apply the word-title partial-CNN to the title to generate a first word-level feature based on words within the title, and apply the description partial-CNN to the description to generate a second word-level feature based on word within the description. The one or more processors also are configured to generate a posting feature by concatenating the character-level feature, the first word-level feature, and the second word-level feature. The one or more processors also are configured to determine a numeric representation of a classification for the title by applying the at least one fully-connected layer to the posting feature. The example disclosed system also includes a posting database in which the one or more processors are configured to store the employment posting and the numeric representation of the title.

In some examples, each of the character-title partial-CNN, the word-title partial-CNN, and the description CNN includes a series of convolutional layers and pooling layers.

In some examples, the one or more processors are configured to generate the character-level feature by collecting an output of a last layer of the character-title partial-CNN. In some examples, the one or more processors are configured to generate the first word-level feature by concatenating outputs of a plurality of layers of the word-title partial-CNN. In some examples, the one or more processors are configured to generate the second word-level feature by concatenating outputs of a plurality of layers of the description partial-CNN.

In some examples, prior to applying the at least one fully-connected layer to the posting feature, the one or more processors are configured to apply a dropout layer to the posting feature to randomize the posting feature for the at least one fully-connected layer.

In some examples, the numeric representation of the classification for the title includes representations of a major classification group, a minor classification group, a broad classification, and a detailed classification.

In some examples, the at least one fully-connected layer includes parallel fully-connected layers. In such examples, the one or more processors are configured to compare outputs of the parallel fully-connected layers to determine the numeric representation of the classification for the title. In some such examples, the parallel fully-connected layers include a major fully-connected layer. In such examples, the one or more processors are configured to generate a second numeric representation by applying the major fully-connected layer to the posting feature. In such examples, the second numeric representation represents a major classification group. Further, in some such examples, the parallel fully-connected layers include a detailed fully-connected layer. In such examples, the one or more processors are configured to generate a third numeric representation by applying the detailed fully-connected layer to the posting feature. In such examples, the third numeric representation includes representations of a major classification group, a minor classification group, a broad classification, and a detailed classification. Moreover, in some such examples, in response to determining that the second numeric representation matches the representation of the major classification group of the third numeric representation, the one or more processors are configured to set the third numeric representation as the numeric representation of the classification for the title. Moreover, in some such examples, in response to determining that the second numeric representation does not match the representation of the major classification group of the third numeric representation, the one or more processors are configured to identify, based on the detailed fully-connected layer, a highest-ranked numeric representation that includes a representation of a major classification group that matches the second numeric representation and set the highest-ranked numeric representation as the numeric representation of the classification for the title.

In some examples, the one or more processors are configured to determine the numeric representation of the classification for the title in real-time upon collecting the employment posting from a recruiter via an employment website or app.

Some examples further include a candidate database. In such examples, in real-time, the one or more processors are configured to match the employment posting with one or more candidate profiles retrieved from the candidate database based on the numeric representation of the classification for the title.

In some examples, the one or more processors are configured to collect candidate information from a candidate via an employment website or app, identify the numeric representation of the classification as corresponding with the candidate based on the candidate information, retrieve the employment posting from the posting database based on the numeric representation, and recommend, in real-time, the employment posting to the candidate via the employment website or app.

An example disclosed method for automatically classifying employment titles of employment postings includes collecting, via one or more processors, an employment posting. The example disclosed method also includes extracting, via the one or more processors, text of the employment posting and identifying, via the one or more processors, a title and a description within the extracted text. The example disclosed method also includes applying a character-title partial-CNN of a convolutional neural network (CNN) to the title to generate a character-level feature based on characters within the title, applying a word-title partial-CNN of the CNN to the title to generate a first word-level feature based on words within the title, and applying a description partial-CNN of the CNN to the description to generate a second word-level feature based on word within the description. The example disclosed method also includes generating a posting feature by concatenating the character-level feature, the first word-level feature, and the second word-level feature. The example disclosed method also includes determining a numeric representation of a classification for the title by applying at least one fully-connected layer of the CNN to the posting feature and storing the employment posting and the numeric representation of the title in a posting database.

In some examples, applying the at least one fully-connected layer to the posting feature includes applying a major fully-connected layer to the posting feature to generate a second numeric representation that represents a major classification group, applying a detailed fully-connected layer to the posting feature to generate a third numeric representation, and comparing the second and third numeric representations. In such examples, the third numeric representation includes representations of a major classification group, a minor classification group, a broad classification, and a detailed classification. Some such examples further include, in response to determining that the second and third numeric representations correspond with each other, setting the third numeric representation as the numeric representation of the classification for the title. Some such examples further include, in response to determining the second and third numeric representations do not correspond with each other, identifying, based on the detailed fully-connected layer, a highest-ranked numeric representation that includes a representation of a major classification group that matches the second numeric representation and setting the highest-ranked numeric representation as the numeric representation of the classification for the title.

An example tangible computer readable medium includes instructions which, when executed, cause a machine to automatically classify employment titles of employment postings. The instructions which, when executed, also cause the machine to collect an employment posting, extract text of the employment posting, and identify a title and a description within the extracted text. The instructions which, when executed, cause the machine to apply a character-title partial-CNN of a convolutional neural network (CNN) to the title to generate a character-level feature based on characters within the title, apply a word-title partial-CNN of the CNN to the title to generate a first word-level feature based on words within the title, and apply a description partial-CNN of the CNN to the description to generate a second word-level feature based on word within the description. The instructions which, when executed, cause the machine to generate a posting feature by concatenating the character-level feature, the first word-level feature, and the second word-level feature. The instructions which, when executed, cause the machine to determine a numeric representation of a classification for the title by applying at least one fully-connected layer of the CNN to the posting feature and store the employment posting and the numeric representation of the title in a posting database.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example environment in which an employment website entity collects a job posting in accordance with the teachings herein.

FIG. 2 is a block diagram of example components of the employment website entity of FIG. 1 for classifying a job title of a job posting.

FIG. 3 is a block diagram of example electronic components of the employment website entity of FIG. 1.

FIG. 4 is an example job posting collected by the employment website entity of FIG. 1.

FIG. 5 is an example table of job title classifications.

FIG. 6 is block diagram of an example convolutional neural network for classifying a job title of a job posting.

FIG. 7 is an example flowchart for classifying a job title of a job posting via machine learning.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Example methods and apparatus disclosed herein classify a job title of a job posting in an automated manner to facilitate an employer in a finding a job seeker of interest and/or a job seeker in finding a job of interest on an employment website and/or app. Examples disclosed herein utilize a convolutional neural network to classify a job title of a job posting in real-time to enable an employment website and/or app to recommend job seeker(s) to an employer based on the classification in real-time. Further, examples disclosed herein utilize a convolutional neural network to classify a job title of a job posting in real-time to enable an employment website and/or app to recommend job(s) to a job seeker based on the classification.

Examples disclosed herein include a robust convolutional neural network that improves the accuracy of automatic classifications of job titles of job postings. An example convolutional neural network (CNN) disclosed herein include three parallel partial-CNNs. A first partial-CNN is applied to a job title of a job posting to generate a first feature matrix or vector based on characters of the job title, a second partial-CNN is applied to a job title to generate a second feature matrix or vector based on words of the job title, and a third partial-CNN is applied to a description of the job posting to generate a third feature matrix or vector based on words of the description. The three feature matrices or vectors are concatenated together and fed into one or more fully-connected layers of the CNN to generate a classification of the job title. For example, a CNN disclosed herein includes two fully-connected layers in parallel to each other. Outputs of the two fully-connected layers are compared to each other to determine the classification of the job title.

By applying a CNN to a job title and a corresponding description of a job posting, the example methods and apparatus disclosed herein enable the job title to be classified in an accurate and efficient automated manner. Thus, examples disclosed herein include a specific set of rules that apply a unique and unconventionally-structured CNN to online job postings to address the technological need to accurately and efficiently classify and index large quantities of job titles of respective job postings submitted to an employment website and/or app.

As used herein, an “employment website entity” refers to an entity that operates and/or owns an employment website and/or an employment app. As used herein, an “employment website” refers to a website and/or any other online service that facilitates job placement, career, and/or hiring searches. Example employment websites include CareerBuilder.com®, Sologig.com®, etc. As used herein, an “employment app” and an “employment application” refer to a process of an employment website entity that is executed on a desktop computer, on a mobile device, and/or within an Internet browser of a candidate and/or a recruiter. For example, an employment application includes a desktop application that is configured to operate on a desktop computer, a mobile app that is configured to operate on a mobile device (e.g., a smart phone, a smart watch, a wearable, a tablet, etc.), and/or a web application that is configured to operate within an Internet browser (e.g., a mobile-friendly website configured to be presented via a touchscreen of a mobile device).

As used herein, a “candidate” and a “job seeker” refer to a person who is searching for a job, position, and/or career. As used herein, a “recruiter” refers to a person and/or entity (e.g., a company, a corporation, etc.) that solicits one or more candidates to apply for a position and/or a job. For example, a recruiter may include an employer, an employee and/or other representative (e.g., a human resources representative, etc.) of an employer, and/or third-party headhunter.

As used herein, “real-time” refers to a time period that is simultaneous to and/or immediately after a candidate and/or a recruiter enters input information into an employment website and/or app. For example, real-time includes a time duration after a session of a candidate with an employment website and/or app starts and before the session of the candidate with the employment website and/or app ends. As used herein, a “session” refers to an interaction between a candidate and/or recruiter and an employment website and/or app. Typically, a session will be relatively continuous from a start point to an end point. For example, a session may begin when the candidate and/or recruiter opens and/or logs onto the employment website and/or app and may end when the candidate and/or recruiter closes and/or logs off of the employment website and/or app.

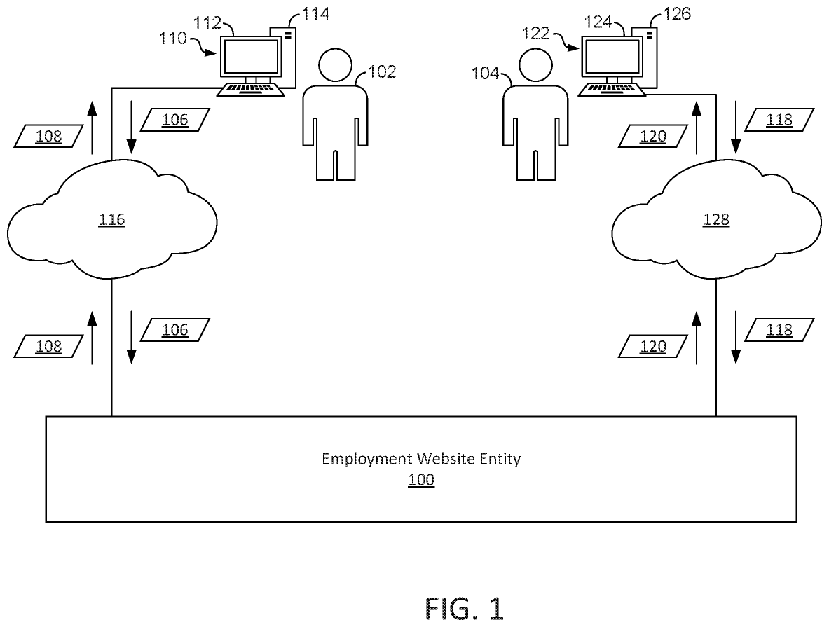

Turning to the figures, FIG. 1 illustrates an example employment website entity 100 (e.g., CareerBuilder.com®). The employment website entity 100 is configured to collect employment information from and present employment information to a recruiter 102 and a candidate 104. For example, the employment website entity 100 facilitates the recruiter 102 in finding an employee for an open position and/or facilitates the candidate 104 in finding employment.

In the illustrated example, the employment website entity 100 is configured to collect recruiter information 106 from the recruiter 102 and provide candidate information 108 to the recruiter 102. The recruiter information 106 may include job posting(s), employer information (e.g., description, history, contact information), etc. Further, the candidate information 108 may include information of candidate(s) (e.g., profile information, resume(s), contact information, etc.) that have applied and/or been recommended for a job posting of the recruiter 102. In the illustrated example, the employment website entity 100 is configured to collect the recruiter information 106 from and provide the candidate information 108 to the recruiter 102 via an employment website and/or app 110. For example, a display 112 (e.g., a touchscreen, a non-touch display, etc.) and/or other output device(s) of a computing device 114 (e.g., a computer, a desktop, a laptop, a mobile device, a tablet, etc.) presents the candidate information 108 and/or other information to the recruiter 102 via the employment website and/or app 110. Further, the computing device 114 includes input device(s) (e.g., a touchscreen, a keyboard, a mouse, a button, a microphone, etc.) that enable the recruiter 102 to input the recruiter information 106 and/or other information into the employment website and/or app 110.

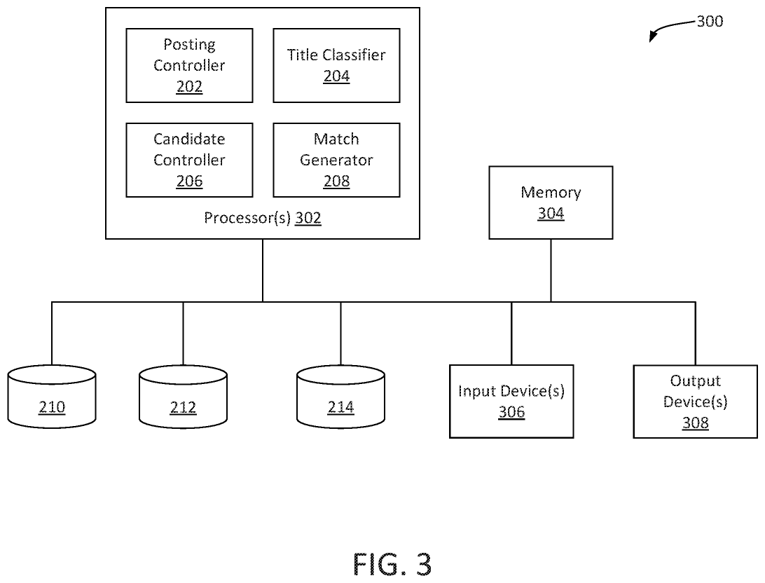

As illustrated in FIG. 1, the computing device 114 of the recruiter 102 and processor(s) of the employment website entity 100 (e.g., one or more processors 302 of FIG. 3) are in communication (e.g., via a wired and/or a wireless connection) with each other via a network 116. The network 116 may be a public network, such as the Internet; a private network, such as an intranet; or combinations thereof.

Further, in the illustrated example, the employment website entity 100 is configured to collect candidate information 118 from the candidate 104 and provide employment information 120 to the candidate 104. The candidate information 118 may include information (e.g., profile information, resume(s), contact information, etc.) of the candidate 104. Further, the employment information 120 may include job posting(s), employer information (e.g., description, history, contact information), recruiter information, etc. that facilitates the candidate 104 in finding employment opportunities. In the illustrated example, the employment website entity 100 is configured to collect the candidate information 118 from and provide the employment information 120 to the candidate 104 via an employment website and/or app 122. The employment website and/or app 122 for the candidate 104 may similar to and/or different than the employment website and/or app 110 for the recruiter 102. For example, the employment website entity 100 may include an employment website and/or app that has one portal for recruiters and a different portal for job seekers. Further in the illustrated example, a display 124 (e.g., a touchscreen, a non-touch display, etc.) and/or other output device(s) of a computing device 126 (e.g., a computer, a desktop, a laptop, a mobile device, a tablet, etc.) presents the employment information 120 and/or other information to the candidate 104 via the employment website and/or app 122. The computing device 126 also includes input device(s) (e.g., a touchscreen, a keyboard, a mouse, a button, a microphone, etc.) that enable the candidate 104 to input the candidate information 118 and/or other information into the employment website and/or app 122.

As illustrated in FIG. 1, the computing device 126 of the candidate 104 and the processor(s) of the employment website entity 100 are in communication (e.g., via a wired and/or a wireless connection) with each other via a network 128. The network 128 may be a public network, such as the Internet; a private network, such as an intranet; or combinations thereof. In the illustrated example, the network 128 is separate from the network 116. In other examples, the network 128 and the network 116 are integrally formed.

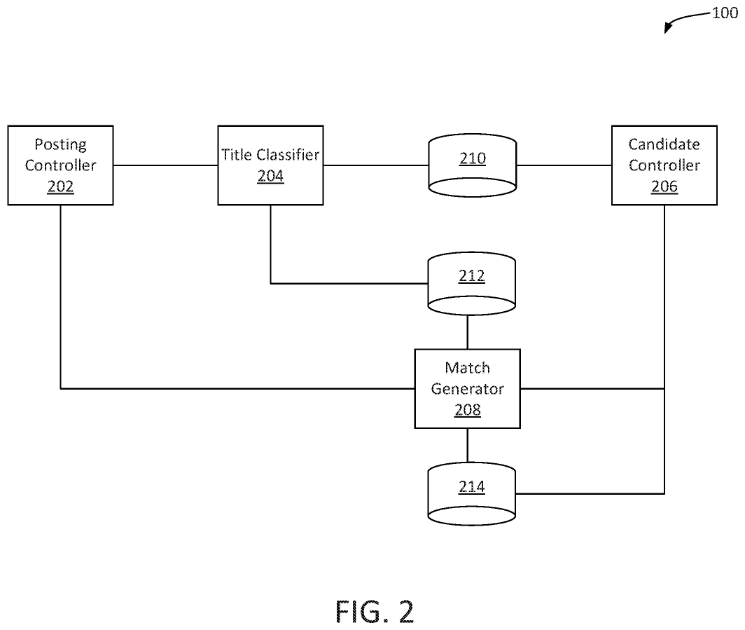

FIG. 2 is a block diagram of components of one or more processors (e.g., one or more processors 302 of FIG. 3) of the employment website entity 100 for accurately and efficiently classifying employment titles of employment postings for employment websites and/or apps. As illustrated in FIG. 2, the components of the processor(s) of the employment website entity 100 include a posting controller 202, a title classifier 204, a candidate controller 206, and a match generator 208. Further, the components of the illustrated example include a title database 210, a posting database 212, and a candidate database 214.

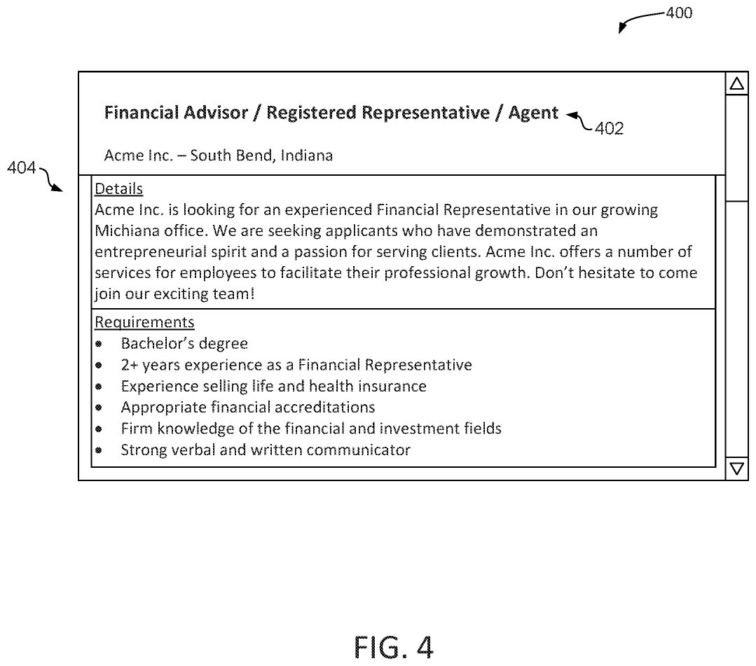

The posting controller 202 of the illustrated example is configured to collect an employment posting (e.g., an employment posting 400 of FIG. 4). For example, the posting controller 202 is configured to collect the employment posting from (i) a recruiter who has submitted the employment posting via an employment website and/or app (e.g., from the recruiter 102 via the employment website and/or app 110), (ii) from a database (e.g., the posting database 212), (iii) from a website and/or requisition database of a third-party entity, etc. Upon collecting the employment posting, the posting controller 202 is configured to extract the text of the collected employment posting. Further, the posting controller 202 is configured to identify an employment title (e.g., a title 402 of FIG. 4) and a description (e.g., a description 404 of FIG. 4) of the employment posting within the extracted text. For example, the posting controller 202 is configured to parse the extracted text to identify the employment title and the description.

The title classifier 204 is configured to automatically identify a standardized classification (also referred to as a standardized occupation classification) for the employment title of the employment posting. For example, the title classifier 204 is configured to automatically identify the standardized classification for the employment title in real-time upon collecting the employment posting from the recruiter 102 via the employment website and/or app 110. An example standardized classification is the Standard Occupational Classification (SOC) System, such as the recently released 2018 SOC System. The United States government generates the SOC System, which is a hierarchical classification system for occupations, to facilitate the comparison of occupations across data sets.

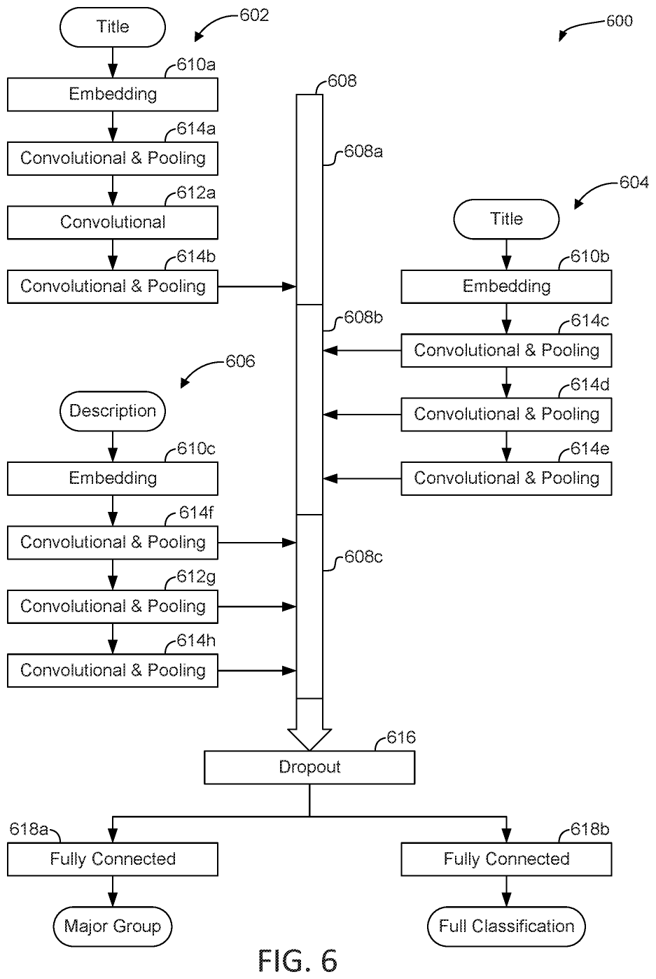

Further, the title classifier 204 is configured to utilize a machine learning model to identify the standardized classification for the employment title. For example, the title classifier 204 is configured to apply a convolutional neural network (e.g., a convolutional neural network 600 of FIG. 6) to the employment title and the description of the employment posting to determine a numeric representation of the corresponding standardized classification of the employment title. In some examples, the title classifier 204 is configured to determine the numeric representation of the standardized classification in real-time upon the posting controller 202 collecting the employment posting from the recruiter 102 via the employment website and/or app 110.

Machine learning models are a form of artificial intelligence (AI) that enable a system to automatically learn and improve from experience without being explicitly programmed by a programmer for a particular function. For example, machine learning models access data and learn from the accessed data to improve performance of a particular function. Exemplary types of machine learning models include decision trees, support vectors, clustering, Bayesian networks, sparse dictionary learning, rules-based machine learning, etc. Another type of machine learning model is an artificial neural network, which is inspired by biological neural networks. An artificial neural network includes a collection of nodes that are organized in layers to perform a particular function (e.g., to categorize an input). Each node is trained (e.g., in an unsupervised manner) to receive an input signal from a node of a previous layer and provide an output signal to a node of a subsequent layer. An exemplary type of artificial neural network is a convolutional neural network.

A convolutional neural network is a type of artificial neural network that includes one or more convolutional layers, one or more pooling layers, and one or more fully-connected layers to perform a particular function. For example, a convolutional neural network includes convolutional layer(s) and fully-connected layer(s) to identify and/or categorize word(s) within text. Typically, the convolutional layer(s) are performed before the fully-connected layer(s).

A convolutional layer includes one or more filters (also known as kernels or feature detectors). Each filter is a weighted matrix (e.g., a 3×3 matrix, a 5×5 matrix, a 7×7 matrix). For example, a first element of the matrix has a weight of “1,” a second element of the matrix has a weight of “0,” a third element of the matrix has a weight of “2,” etc. Further, each filter is convolved across the length and width of an input matrix to generate a feature map (e.g., a matrix, a vector) corresponding to that filter. A convolution refers to a mathematical combination of two functions to produce another function to express how one function affects another. For example, a filter is convolved across an input matrix by computing a dot product between a weighted matrix of the filter and a numerical representation of a tile of elements of the input matrix. For image recognition applications, the input matrix typically includes numeric representations of pixels of an input image. For natural language processing (NLP) applications, the input matrix typically includes numeric representations words of characters within a block of text. For example, each row within the input matrix for an NLP application corresponds with a particular word or character within the block of text (e.g., via word2vec or char2vec representation). For example, word2vec is a neural network model (e.g., a 2-layer neural network) that generates a vector space representing words within a corpus or block of text, and char2vec is a neural network model (e.g., a 2-layer neural network) that generates a vector space representing characters within a corpus or block of text (e.g., a relatively small text corpus such as a single word, title, or phrase).

Further, each filter is trained to detect a particular feature within the tiles of the input matrix. In turn, each feature map includes information for that particular feature within the input matrix. By convolving a filter across the input matrix, the convolutional layer is able to obtain identification information for a plurality of features (e.g., sentence structure, spelling, etc.) while also reducing a size of information being analyzed to increase processing speeds. Thus, because each filter of a convolutional layer generates a respective feature map, a convolutional layer with a plurality of filters generates a plurality of feature maps. In some examples, the plurality of feature maps are concatenated to form a single feature matrix or feature vector. Further, a subsequent convolutional layer receives the feature maps as input information to be analyzed.

A convolutional neural network also typically includes one or more pooling layer(s). In some examples, a convolutional neural network includes a pooling layer after each convolutional layer such that each pooling layer is connected to a preceding convolutional layer. In other examples, a convolutional neural network may include more or less pooling layers and/or may arrange the pooling layers differently relative to the convolutional layers. A pooling layer is a form of down-sampling that is configured to further reduce the size of the input matrix being analyzed to further increase processing speeds. For example, a pooling layer partitions each feature map into a grid of non-overlapping sections. Each non-overlapping section includes a cluster of data points within the feature map. For example, each pool may consist of a 2×2 grid of data points. For each non-overlapping section, the pooling layer generates one value based on the corresponding data points. In some examples, the pooling layer includes max pooling in which the generated value is the highest value of the corresponding data points. In other examples, the pooling layer includes min pooling in which the generated value is the lowest value of the corresponding data points or average pooling in which the generated value is the average of the corresponding data points. Further, in some examples, a convolutional layer further includes one or more rectified linear unit (ReLU) layers to further reduce the size of the input matrix being analyzed. A ReLU is a non-linear function that changes each negative value within a feature map to a value of “0.”

After the convolutional and pooling layers are performed, one or more fully-connected layers of the convolutional neural network are performed. The fully-connected layer(s) are configured to identify features of and/or objects within the input matrix based on the information generated by the convolution and pooling layers. Each fully-connected layer includes a plurality of nodes. Each node is connected to each node or map value of the previous layer, and each connection to the previous layer has its own respective weight. Further, each node is trained (e.g., in an unsupervised manner) to provide an output signal to a node of subsequent layer. In some examples, the final fully-connected layer generates a value representing a likelihood or certainty that a characteristic is or is not present in the input matrix. Further, in some examples, the convolutional neural network back-propagates the corresponding uncertainty through the convolutional neural network to retrain and improve the convolutional neural network for subsequent input matrices.

In the illustrated example, the title classifier 204 is configured to feed the employment title and the description of the employment posting to a plurality of partial-CNNs of the convolutional neural network to identify the corresponding standardized classification of the employment title. As used herein, a “partial-CNN” refers to a plurality of layers of a convolutional neural network, such as convolutional layer(s) and/or pooling layer(s), that are connected to each other in series between an input matrix and a fully-connected layer.

For example, the title classifier 204 is configured to apply a character-title partial-CNN (e.g., a character-title partial-CNN 602 of FIG. 6) to the employment title of the employment posting to generate a character-level feature (e.g., a character-level feature 608a of FIG. 6) based on characters within the employment title. That is, the title classifier 204 is configured to apply the character-title partial-CNN to an input matrix (e.g., a first input matrix) formed from characters of the employment title to generate a character-level feature vector or matrix. Further, the title classifier 204 is configured to apply a word-title partial-CNN (e.g., a word-title partial-CNN 604 of FIG. 6) to the employment title of the employment posting to generate a first word-level feature (e.g., a word-level feature 608b of FIG. 6) based on words within the employment title. That is, the title classifier 204 is configured to apply the word-title partial-CNN to another input matrix (e.g., a second input matrix) formed from words of the employment title to generate a first word-level feature vector or matrix. The title classifier 204 also is configured to apply a description partial-CNN (e.g., a description partial-CNN 606 of FIG. 6) to the description of the employment posting to generate a second word-level feature (e.g., a word-level feature 608c of FIG. 6) based on words within the description. That is, the title classifier 204 is configured to apply the description partial-CNN to yet another input matrix (e.g., a third input matrix) formed from words of the description of the employment posting to generate a second word-level feature vector or matrix.

The title classifier 204 of the illustrated example also is configured to concatenate together the character-level feature, the first word-level feature, and the second word-level feature to form a posting feature matrix or vector. That is, the posting feature generated by the title classifier 204 is a concatenation of the character-level feature generated by the character-title partial-CNN, the first word-level feature generated by the word-title partial-CNN, and the second word-level feature generated by the description partial-CNN. Further, upon forming the posting feature, the title classifier 204 determine a numeric representation of a classification for the employment title of the employment posting by applying one or more fully-connected layers (e.g., one or more fully-connected layers 618 of FIG. 6).

In some examples, the numeric representation includes a plurality of digits. For example, numeric representations based on the SOC system include six digits in the form of “##-####.” With such a numeric representation, the first two digits (i.e., the first and second digits) correspond with a major classification group, the next two digits (i.e., the third and fourth digits) correspond with a minor classification group within the major classification group, the next digit (i.e., the fifth digit) corresponds with a broad classification within the minor classification group, and the next digit (i.e., the sixth digit) corresponds with a detailed classification within the broad classification. For example, within the 2018 SOC system, the numeric representation for the standardized classification of a “Personal Financial Advisor,” such as a Estate Planner or a Personal Investment Adviser, is “13-2052.” The first two digits, “13,” correspond with the major classification group of “Business and Financial Operations.” The next two digits, “20,” correspond with the minor classification group of “Financial Specialists.” The next digit, “5,” corresponds with the broad classification of “Financial Analysts and Advisors.” The last digit “2,” corresponds with the detailed classification of “Personal Financial Advisors.”

In the illustrated example, the title database 210 is configured to store associations between standardized classifications (e.g., Financial Analysts and Advisors) and their respective numeric representations (e.g., 13-2052) to facilitate the identification of a standardized classification that corresponds with a numeric representation corresponding with an employment posting. For example, upon identifying a numeric representation of a standardized classification by applying the convolutional neural network to an employment posting, the title database 210 is configured to retrieve the standardized classification from the title database 210 based on the corresponding numeric representation.

The title classifier 204 also is configured to store the employment posting and the corresponding numeric representation in the posting database 212. In some examples, the title classifier 204 is configured to (1) retrieve the standardized classification that corresponds with the numeric representation from the title database 210 and subsequently (2) store the standardized classification in the posting database 212 with the numeric representation and the employment posting.

Further, the candidate controller 206 of the illustrated example is configured to collect the candidate information 118 from the candidate 104 via the employment website and/or app 122. In some examples, the candidate controller 206 is configured to determine a numeric representation of a standardized occupation classification based on the candidate information 118 in a manner identical and/or otherwise substantially similar to the title classifier 204 determining a standardized occupation classification for an employment posting. Additionally or alternatively, the candidate controller 206 is configured to provide the candidate information 118 to the title classifier 204 to enable the title classifier 204 to determine the numeric representation of the standardized occupation classification for the candidate 104. The candidate controller 206 also is configured to store a candidate profile and the corresponding numeric representation in the candidate database 214. In some examples, the candidate controller 206 is configured to (1) retrieve the standardized occupation classification that corresponds with the numeric representation from the title database 210 and subsequently (2) store the standardized occupation classification in the candidate database 214 with the numeric representation and the employment posting.

The match generator 208 is configured to retrieve employment posting(s) from the posting database 212 and/or candidate profiles from the candidate database 214 based on numeric representation(s) of standardized occupation classification(s) to facilitate matching and/or recommendation(s) between recruiter(s) and candidate(s). For example, in real-time during a session of the recruiter 102 on the employment website and/or app 110, the title classifier 204 is configured to determine a numeric representation of a standardized classification based on an employment posting collected by the posting controller 202. Based on the numeric representation, the match generator 208 is configured to match the employment posting with one or more candidate profiles by retrieving those profiles from the candidate database 214 based on the numeric representation. Subsequently, in real-time, the posting controller 202 is configured to present the matched candidate profiles to the recruiter 102 via the employment website and/or app 110. Additionally or alternatively, in real-time during a session of the candidate 104 on the employment website and/or app 122, the candidate controller 206 and/or the title classifier 204 is configured to determine a numeric representation of a standardized classification based on a candidate profile of the candidate 104. Based on the numeric representation, the match generator 208 is configured to match the candidate 104 with one or more employment postings by retrieving those profiles from the posting database 212 based on the numeric representation. Subsequently, in real-time, the candidate controller 206 is configured to present the matched employment postings via the employment website and/or app 122 as recommendation employment postings for the candidate 104.

FIG. 3 is a block diagram of electronic components 300 of the employment website entity 100. As illustrated in FIG. 3, the electronic components 300 include one or more processors 302 (also referred to as microcontroller unit(s) and controller(s)). Further, the electronic components 200 include memory 304, input device(s) 306, output device(s) 308, the title database 210, the posting database 212, and the candidate database 214. In the illustrated example, each of the title database 210, the posting database 212, and the candidate database 214 is a separate database. In other examples, the title database 210, the posting database 212, and/or the candidate database 214 are integrally formed.

In the illustrated example, the processor(s) 302 are structured to include the posting controller 202, the title classifier 204, the candidate controller 206, and the match generator 208. The processor(s) 302 of the illustrated example include any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). Further, the memory 304 is, for example, volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, the memory 304 includes multiple kinds of memory, such as volatile memory and non-volatile memory.

The memory 304 is computer readable media on which one or more sets of instructions, such as the software for operating the methods of the present disclosure, can be embedded. The instructions may embody one or more of the methods or logic as described herein. For example, the memory 304 is configured to store a machine learning model (e.g., a convolutional neural network 600 of FIG. 6) and/or instructions to apply the machine learning model. The instructions may embody one or more of the methods or logic as described herein. Further, the instructions reside completely, or at least partially, within any one or more of the memory 304, the computer readable medium, and/or within the processor(s) 302 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

In the illustrated example, the input device(s) 306 enable a user, such as an information technician of the employment website entity 100, to provide instructions, commands, and/or data to the processor(s) 302. Examples of the input device(s) 306 include one or more of a button, a control knob, an instrument panel, a touch screen, a touchpad, a keyboard, a mouse, a speech recognition system, etc.

The output device(s) 308 of the illustrated example display output information and/or data of the processor(s) 302 to a user, such as an information technician of the employment website entity 100. Examples of the output device(s) 308 include a liquid crystal display (LCD), an organic light emitting diode (OLED) display, a flat panel display, a solid state display, and/or any other device that visually presents information to a user. Additionally or alternatively, the output device(s) 308 may include one or more speakers and/or any other device(s) that provide audio signals for a user. Further, the output device(s) 308 may provide other types of output information, such as haptic signals.

FIG. 4 is an example employment posting 400 collected by the posting controller 202 of the employment website entity 100. As illustrated in FIG. 4, the employment posting 400 includes a title 402 (“Financial Advisor/Registered Representative/Agent”) and a description 404. For example, the description 404 includes a details section, a requirements section, and/or other section(s) that describe a position and/or employer associated with the employment posting 400. Upon collecting the employment posting 400, the posting controller 202 is configured to (1) extract the text of the employment posting 400, (2) identify the title 402 and the description 404 within the extracted text, and (3) feed the title 402 and the description 404 into a convolution neural network (e.g., a convolutional neural network 600 of FIG. 6) to determine a standardized classification of the title 402.

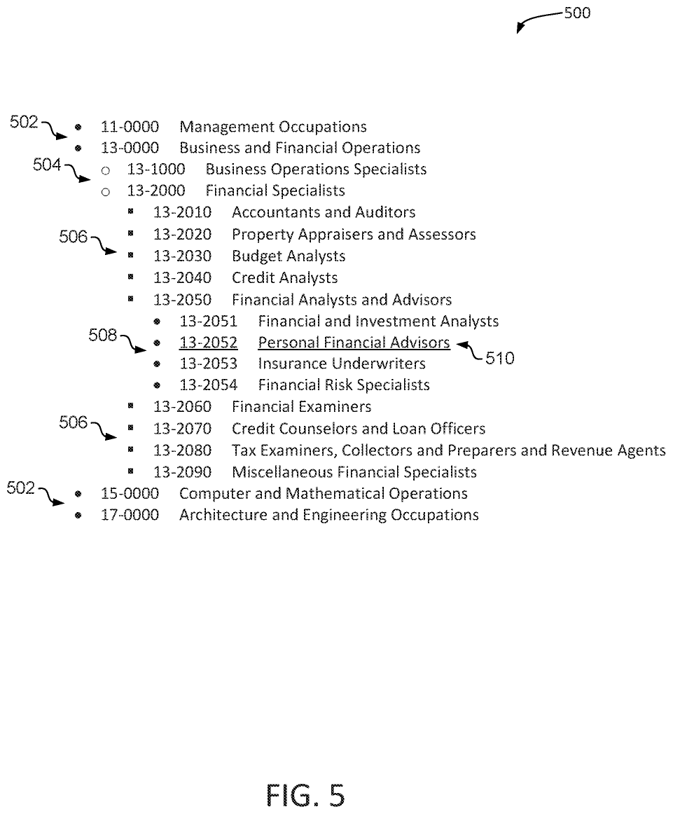

FIG. 5 a portion of an example table 500 that identifies numeric representations of classification groups and classifications of occupations identified within the title database 210. For example, the table 500 includes numeric representations of classification groups and classifications as identified in the 2018 SOC system. As illustrated in FIG. 5, the table 500 includes major classification groups 502, minor classification groups 504, broad classifications 506, and detailed classifications 508. Further, the table 500 includes the numeric representations of the major classification groups 502, the minor classification groups 504, the broad classifications 506, and the detailed classifications 508.

For example, the table 500 identifies numeric representations of the “Management Occupations” major classification group (“11-0000”), the “Business and Financial Operations” major classification group (“13-0000”), the “Computer and Mathematical Operations” major classification group (“15-0000”), and the “Architecture and Engineering Operations” major classification group (“17-0000”). The table 500 also identifies numeric representations of the “Business Operations Specialists” minor classification group (“13-1000”) and the “Financial Specialists” minor classification group (“13-2000”) of the “Business and Financial Operations” major classification group. Further, the table 500 identifies numeric representations of the broad classifications 506 of the “Financial Specialists” minor classification group, such as the “Accountants and Auditors” broad classification (“13-2010”), the “Budget Analysts” broad classification (“13-2030”), the “Financial Analysts and Advisors” broad classification (“13-2050”), etc. Additionally, the table 500 identifies numeric representations of the detailed classifications 508 of the “Financial Analysts and Advisors” broad classification, which include the “Financial and Investment Analysts” detailed classification (“13-2051”), the “Personal Financial Advisors” detailed classification (“13-2052”), the “Insurance Underwriters” detailed classification (“13-2053”), and the “Financial Risk Specialists” detailed classification (“13-2054”).

In the illustrated example, the “Personal Financial Advisors” detailed classification is underlined to indicate that it corresponds with a standardized occupation classification 510 of the title 402 of the employment posting 400. That is, the standardized occupation classification 510 of the title 402 of the employment posting 400 is “Personal Financial Advisors” and the corresponding numeric representation is “13-2052.”

FIG. 6 is block diagram of an example convolutional neural network 600 configured for natural language processing (NLP). More specifically, the convolutional neural network 600 is configured to identify a standardized occupation classification for an employment title of an employment posting. For example, the convolutional neural network 600 is configured to be fed the employment posting 400 by the title classifier 204 of the processor(s) 302 of the employment website entity 100 to classify the title 402 of the employment posting 400. Further, the convolutional neural network 600 of the illustrated example is a robust convolutional neural network that is configured to accurately and efficiently identify the standardized classification of a title of an employment posting. For example, the convolutional neural network 600 is configured to perform both local matching on a character level (e.g., analysis based on spelling, character patterns, etc.) and semantic matching on a word and/or sentence level (e.g., analysis based on sentence structure, etc.) upon being fed both a title and a description of an employment posting as inputs to improve the accuracy of the standardized classification.

In the illustrated example the convolutional neural network 600 includes a character-title partial-CNN 602, a word-title partial-CNN 604, and a description partial-CNN 606, which are configured to generate a posting feature 608. For example, the posting feature 608 is a feature vector or matrix with information for one or more features (e.g., spelling, sentence structure, punctuation, etc.) identified based on the title 402 and the description of the employment posting 400 that is subsequently processed to identify a standardized occupation classification 510 of the title 402. In the illustrated example, the convolutional neural network 600 includes one or more embedding layers 610, one or more convolutional layers 612, and one or more convolutional and pooling layers 614 in the character-title partial-CNN 602, the word-title partial-CNN 604, and the description partial-CNN 606. For example, each of the character-title partial-CNN 602, the word-title partial-CNN 604, and the description partial-CNN 606 includes a series of the convolutional and pooling layers 614.

The embedding layers 610 enable the convolutional neural network 600 to analyze the employment posting 400. For example, each of the embedding layers 610 is configured to embed the characters, words, and/or sentences of the employment posting 400 as numeric representations in a vector to facilitate subsequent analysis. In some examples, one or more of the embedding layers 610 utilizes char2vec embedding in which each vector corresponds with a respective character of the employment posting 400. Further, in some examples, one or more of the embedding layers 610 utilizes word2vec embedding in which each vector corresponds with a respective word of the employment posting 400.

The convolutional layers 612 of the illustrated example is configured to extract local or semantic features of an input layer (e.g., the embedded form of the title 402 and/or the description 404 of the employment posting 400) by mapping the input layer to a higher dimensional space with different sizes and filter values. Each of the convolutional layers 612 includes one or more filters that is a weighted matrix. Each filter is convolved across the length, width, and/or other dimension of an input vector or matrix to generate a feature vector or matrix corresponding to that filter. Further, each filter is trained to detect a particular feature within the tiles of the input vector matrix. In turn, each feature vector or matrix includes information for that particular feature within the input vector or matrix. By convolving a filter across the input vector matrix, the convolutional layer is able to obtain identification information for a plurality of features (e.g., spelling, sentence structure, punctuation, etc.) while also reducing a size of information for subsequent analysis.

Each of the convolutional and pooling layers 614 of the illustrated example includes a convolutional layer that is connected to a subsequent pooling layer in series. That is, within each of convolutional and pooling layers 614, a pooling layer is connected to a preceding convolutional layer. A pooling layer is a form of down-sampling that is configured to further reduce the size of an input layer being analyzed, for example, to increase processing speeds. In the illustrated example, each of the pooling layers is a max pooling layer in which a generated output value is the highest value of corresponding input data points. In other examples, one or more of the pooling layer may include a min pooling layer in which the generated output value is the lowest value of the corresponding input data points, an average pooling layer in which the generated output value is the average of the corresponding input data points, and/or any other type of pooling layer.

In the illustrated example, the character-title partial-CNN 602 includes an embedding layer 610a, a convolutional layer 612a, and convolutional and pooling layers 614a, 614b that are connected together in series. The character-title partial-CNN 602 is configured to generate a character-level feature 608a upon being applied to the title 402 of the employment posting 400. The character-level feature 608a is a feature vector or matrix that includes one or more character features (e.g., spelling, character patterns, etc.) identified within the title 402.

As illustrated in FIG. 6, the title 402 is fed to the embedding layer 610a to generate an input vector or matrix based on the characters within the title 402 of the employment posting 400. Subsequently, the output of the embedding layer 610a is fed to the convolutional and pooling layers 614a, the output of the convolutional and pooling layers 614a is fed to the convolutional layer 612a, and the output of the convolutional layer 612a is fed to the convolutional and pooling layers 614b. Further, the output of the convolutional and pooling layers 614b forms the character-level feature 608a. That is, the character-level feature 608a is generated by collecting the output of the convolutional and pooling layers 614b. In some examples, lower convolutional layers of the character-title partial-CNN 602 include larger-sized convolution filters to enable the character-title partial-CNN 602 to identify local character features, while maintaining a global overview, of the title 402 of the employment posting 400. Further, in some examples, the convolutional layer 612a without a corresponding pooling layer is positioned between the convolutional and pooling layers 614a, 614b to maintain raw signals from the title 402 of the employment posting 400.

In some examples, the layers of the character-title partial-CNN 602 may be rearranged and/or different. For example, the character-title partial-CNN 602 may include more (e.g., 2, 3, etc.) of the convolutional and pooling layers 614 between the embedding layer 610a and the convolutional layers 612 and/or more (e.g., 2, 3, etc.) of the convolutional layers 612 between the convolutional and pooling layers 614a, 614b. The character-title partial-CNN 602 may also include other type(s) of layer(s), such as a ReLU layer. Further, the outputs of a plurality of layers may be concatenated together to form the character-level feature 608a.

In the illustrated example, the word-title partial-CNN 604 includes an embedding layer 610b and convolutional and pooling layers 614c, 614d, 614e, which are connected together in series. The word-title partial-CNN 604 is configured to generate a word-level feature 608b upon being applied to the title 402 of the employment posting 400. The word-level feature 608b is a feature vector or matrix that includes one or more semantic features (e.g., sentence structure, punctuation, etc.) identified within the title 402.

As illustrated in FIG. 6, the title 402 is fed to the embedding layer 610b to generate an input vector or matrix based on the word(s) within the title 402 of the employment posting 400. Subsequently, the output of the embedding layer 610b is fed to the convolutional and pooling layers 614c, the output of the convolutional and pooling layers 614c is fed to the convolutional and pooling layers 614d, and the output of the convolutional and pooling layers 614d is fed to the convolutional and pooling layers 614e. In the illustrated example, the outputs of the convolutional and pooling layers 614c, 614d, 614e are concatenated together to form the word-level feature 608b. That is, the word-level feature 608b is generated by concatenating the output of convolutional and pooling layers 614c, 614d, 614e. For example, by forming the word-level feature 608b from a concatenation of layer outputs, the word-title partial-CNN 604 is configured to further increase the robustness of the convolutional neural network 600.

In some examples, the layers of the word-title partial-CNN 604 are rearranged and/or different. For example, the word-title partial-CNN 604 may include less (e.g., 1, 2) or more (e.g., 4, 5, etc.) of the convolutional and pooling layers 614. In some examples, the output of one or more of the convolutional and pooling layers 614 may not be concatenated with other outputs to form the word-level feature 608b. The word-title partial-CNN 604 may also include other type(s) of layer(s), such as a ReLU layer.

Further, in the illustrated example, the description partial-CNN 606 includes an embedding layer 610c and convolutional and pooling layers 614f, 614g, 614h, which are connected together in series. The description partial-CNN 606 is configured to generate a word-level feature 608c upon being applied to the description 404 of the employment posting 400. The word-level feature 608c is a feature vector or matrix that includes one or more semantic features (e.g., sentence structure, punctuation, etc.) identified within the description 404.

As illustrated in FIG. 6, the description 404 is fed to the embedding layer 610c to generate an input vector or matrix based on the word(s) within the description 404 of the employment posting 400. Subsequently, the output of the embedding layer 610c is fed to the convolutional and pooling layers 614f, the output of the convolutional and pooling layers 614f is fed to the convolutional and pooling layers 614g, and the output of the convolutional and pooling layers 614g is fed to the convolutional and pooling layers 614h. In the illustrated example, the outputs of the convolutional and pooling layers 614f, 614g, 614h are concatenated together to form the word-level feature 608c. That is, the word-level feature 608c is generated by concatenating the output of the convolutional and pooling layers 614f, 614g, 614h. For example, by forming the word-level feature 608c from a concatenation of layer outputs, the description partial-CNN 606 is configured to further increase the robustness of the convolutional neural network 600.

In some examples, the layers of the description partial-CNN 606 are rearranged and/or different. For example, the description partial-CNN 606 may include less (e.g., 1, 2) or more (e.g., 4, 5, etc.) of the convolutional and pooling layers 614. In some examples, the output of one or more of the convolutional and pooling layers 614 may not be concatenated with other outputs to form the word-level feature 608c. The description partial-CNN 606 may also include other type(s) of layer(s), such as a ReLU layer.

As illustrated in FIG. 6, the character-level feature 608a, the word-level feature 608b, and the word-level feature 608c are concatenated together to form the posting feature 608. For example, the posting feature 608 is formed by concatenating the outputs of parallel partial-CNNs together to further increase the robustness of the convolutional neural network 600. Further, in the illustrated example, the convolutional neural network 600 includes a dropout layer 616. The dropout layer 616 is applied to the posting feature 608 to randomize the posting feature 608 and, thus, further increase the robustness of the convolutional neural network 600. For example, to randomize the posting feature 608, the dropout layer 616 is configured to randomly remove, “drop out,” and/or otherwise ignore one or more data points within the posting feature 608.

The convolutional neural network 600 of the illustrated example also includes fully-connected layers 618. The fully-connected layers 618 are applied to the posting feature 608 to determine which standardized occupation classification corresponds with the title 402 of the employment posting 400. In the illustrated example, the fully-connected layers 618 are applied to the posting feature 608 after the dropout layer 616 is applied to the posting feature 608.

Each of the fully-connected layers 618 in the illustrated example is configured to generate value(s) representing likelihood(s) that respective characteristic(s) are or are not present in the employment posting 400. Further, each of the fully-connected layers 618 includes a plurality of nodes. Each of the nodes is trained (e.g., in an unsupervised manner) to provide a respective output signal. Based on the corresponding output signals, each of the fully-connected layers 618 is configured to generate a value representing a likelihood or certainty that a characteristic (e.g., a major classification group, a full occupation classification) corresponds with the title 402 of the employment posting 400.

The fully-connected layers 618 of the illustrated example include a fully-connected layer 618a and a fully-connected layer 618b. The fully-connected layers 618a, 618b are parallel to each other such that each of the fully-connected layers 618a, 618b is fed the posting feature 608. The outputs of the fully-connected layers 618a, 618b are compared to each other to determine the numeric representation of the standardized occupation classification 510 of the title 402.

In the illustrated example, the fully-connected layer 618a (sometimes referred to as a major fully-connected layer) is configured to generate a numeric representation of a major classification group of a standardized occupation classification (e.g., “13” or “13-0000”). For example, upon being fed the posting feature 608, the fully-connected layer 618a generates a respective likelihood or certainty value for each numeric representation of a respective major classification group. A likelihood or certainty value corresponds with a likelihood that a respective major classification group includes the title 402 of the employment posting 400. Upon generating a likelihood or certainty value for each of the major classification groups, the fully-connected layer 618a outputs the numeric representation with the highest-ranked likelihood or certainty value.

Further, in the illustrated example, the fully-connected layer 618b (sometimes referred to as a detailed fully-connected layer) is configured to generate a numeric representation of a full classification of a standardized occupation classification (e.g., “13-2052”). A full classification includes a major classification group, a minor classification group, a broad classification, and a detailed classification. A likelihood or certainty value corresponds with a likelihood that a respective full classification includes the title 402 of the employment posting 400. Upon generating a likelihood or certainty value for each of the full classifications, the fully-connected layer 618b outputs the numeric representation with the highest-ranked likelihood or certainty value.

Subsequently, to determine the standardized occupation classification 510 of the title 402, the outputs of the fully-connected layers 618a, 618b are compared. For example, a multi-task loss function is applied to the outputs of the fully-connected layers 618a, 618b to enable the output of the fully-connected layer 618a to potentially correct and/or otherwise adjust the output of the fully-connected layer 618b. To compare the outputs of the fully-connected layers 618a, 618b, the numeric representation of a major classification group generated by the fully-connected layers 618a is compared to a portion of the numeric representation generated by the fully-connected layers 618b that corresponds with a major classification group. For example, if the numeric representations output by the fully-connected layers 618a, 618b follow the numbering system of the 2018 SOC system, the first two digits of the respective outputs are compared to each other.

If the first two digits of the output of the fully-connected layer 618a match that of the fully-connected layer 618b, the numeric representation output by the fully-connected layer 618a corresponds with the numeric representation output by the fully-connected layer 618b. In turn, the numeric representation of the full classification output by the fully-connected layer 618b is identified or set as the numeric representation of the standardized occupation classification of the title 402 of the employment posting 400. That is, the full classification of the fully-connected layer 618b is the standardized occupation classification.

If the first two digits of the output of the fully-connected layer 618a do not match that of the fully-connected layer 618b, the numeric representation output by the fully-connected layer 618a does not correspond with the numeric representation output by the fully-connected layer 618b. In turn, the fully-connected layer 618b identifies the numeric representation with the highest-ranked likelihood or certainty value that corresponds with the major classification group identified by the fully-connected layer 618a. For example, if the numeric representation output by the fully-connected layer 618a is “13” or “13-0000,” the fully-connected layer 618b identifies which numeric representation that corresponds with a major classification group of “13” or “13-0000” has the highest-ranked likelihood or certainty value (e.g., “13-2052”). Such numeric representation becomes the output of the fully-connected layer 618b. Subsequently, the numeric representation of the full classification output by the fully-connected layer 618b is identified or set as the numeric representation of the standardized occupation classification of the title 402 of the employment posting 400.

Further, in some examples, the convolutional neural network 600 utilizes back-propagation to improve subsequent performance of the convolutional neural network 600. For example, the convolutional neural network 600 utilizes the sum of (1) a cross-entropy loss function of the fully-connected layer 618a and (2) a cross-entropy loss function of the fully-connected layer 618b for back-propagation. That is, the convolutional neural network 600 is further trained to improve subsequent performance by back-propagating utilizing the sum of the cross-entropy loss functions.

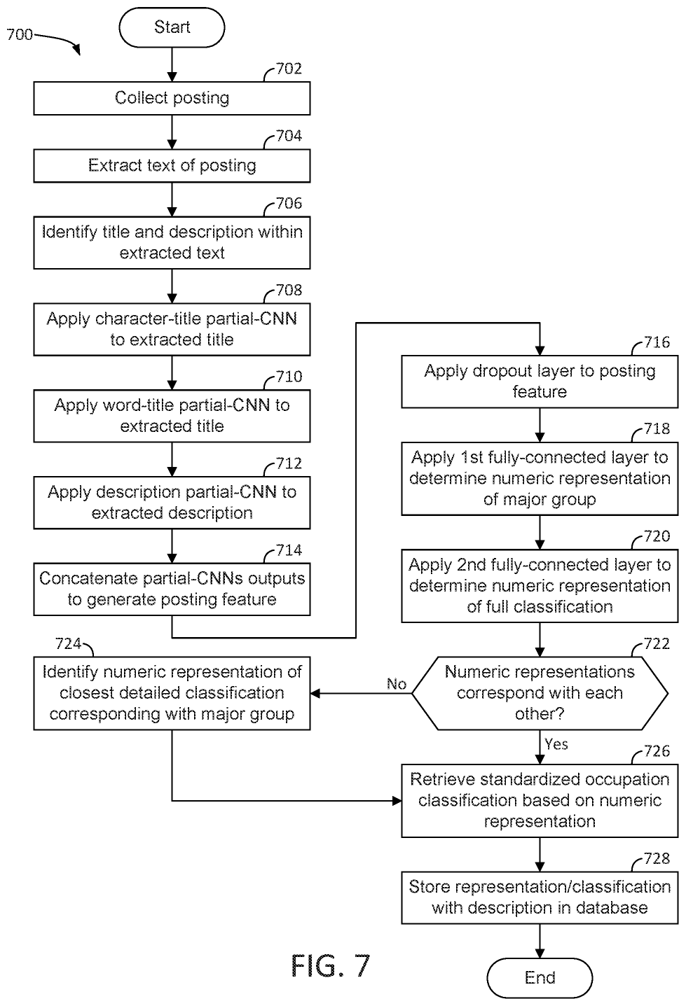

FIG. 7 is a flowchart of an example method 700 to classify a title of an employment posting via machine learning. The flowchart of FIG. 7 is representative of machine readable instructions that are stored in memory (such as the memory 304 of FIG. 3) and include one or more programs which, when executed by one or more processors (such as the processor(s) 302 of FIG. 3), cause the employment website entity 100 to implement the example posting controller 202, the example title classifier 204, the example candidate controller 206, and the example match generator 208 of FIGS. 2-3. While the example program(s) are described with reference to the flowchart illustrated in FIG. 7, many other methods of implementing the example title classifier 204, the example candidate controller 206, and/or the example match generator 208 may alternatively be used. For example, the order of execution of the blocks may be rearranged, changed, eliminated, and/or combined to perform the method 700. Further, because the method 700 is disclosed in connection with the components of FIGS. 1-6, some functions of those components will not be described in detail below

Initially, at block 702, the processor(s) 302 collect an employment posting (e.g., the employment posting 400 of FIG. 4). At block 704, the processor(s) 302 extract text of the employment posting. At block 706, the processor(s) 302 identify a title (e.g., the title 402 of FIG. 4) and a description (e.g., the description 404 of FIG. 4) within the extracted text of the collected employment posting.

At block 708, the processor(s) 302 apply the character-title partial-CNN 602 to the title identified within the extracted text of the collected employment posting. The processor(s) 302 feed the title to the character-title partial-CNN 602 to generate the character-level feature 608a based on characters within the title. At block 710, the processor(s) 302 apply the word-title partial-CNN 604 to the title identified within the extracted text of the collected employment posting. The processor(s) 302 feed the title to the word-title partial-CNN 604 to generate the word-level feature 608b based on words within the title. At block 712, the processor(s) 302 apply the description partial-CNN 606 to the description identified within the extracted text of the collected employment posting. The processor(s) 302 feed the description to the description partial-CNN 606 to generate the word-level feature 608c based on words within the description.

At block 714, the processor(s) 302 generate the posting feature 608 by concatenating the character-level feature 608a generated by the character-title partial-CNN 602, the word-level feature 608b generated by the word-title partial-CNN 604, and the word-level feature 608c generated by the description partial-CNN 606. At block 716, the processor(s) 302 apply the dropout layer 616 to the posting feature 608 to randomize the posting feature 608 and, thus, increase the robustness of the convolutional neural network 600.

At block 718, the processor(s) 302 apply the fully-connected layer 618a to the posting feature 608 to generate a numeric representation of a major classification group. For example, upon being fed the posting feature 608, the fully-connected layer 618a generates a respective likelihood or certainty value for each numeric representation of a respective major classification group. Upon generating a likelihood or certainty value for each of the major classification groups, the fully-connected layer 618a provides the numeric representation with the highest-ranked likelihood or certainty value as an output.

At block 720, the processor(s) 302 apply the fully-connected layer 618b to the posting feature 608, in parallel to applying the fully-connected layer 618a to the posting feature 608 for block 718, to generate a numeric representation of a full classification of the title 402 of the employment posting. For example, upon being fed the posting feature 608, the fully-connected layer 618b generates a respective likelihood or certainty value for each numeric representation of a respective full classification. Upon generating a likelihood or certainty value for each of the full classifications, the fully-connected layer 618b provides the numeric representation with the highest-ranked likelihood or certainty value as an output. By applying the fully-connected layer 618b to the posting feature 608 in parallel to (not necessarily simultaneously with) applying the fully-connected layer 618a to the posting feature 608, the processor(s) 302 are able to compare the numeric representation generated by the fully-connected layer 618a to the numeric representation generated by the fully-connected layer 618b.

At block 722, the processor(s) 302 determine whether the numeric representation output by the fully-connected layer 618a corresponds with the numeric representation output by the fully-connected layer 618b. In response to the processor(s) 302 determining that the numeric representations output by the fully-connected layers 618a, 618b correspond with each other, the method 700 proceeds to block 726. For example, if the numeric representation output by the fully-connected layer 618a is “13” or “13-0000” and the numeric representation output by the fully-connected layer 618b is “13-2052,” the processor(s) 302 determine that the numeric representations output by the fully-connected layers 618a, 618b correspond with each other. In turn, the method 700 proceeds to block 726. Otherwise, in response to the processor(s) 302 determining that the numeric representations output by the fully-connected layers 618a, 618b do not correspond with each other, the method 700 proceeds to block 724. For example, if the numeric representation output by the fully-connected layer 618a is “13” or “13-0000” and the numeric representation output by the fully-connected layer 618b is “11-3031,” the processor(s) 302 determine that the numeric representations output by the fully-connected layers 618a, 618b do not correspond with each other. In turn, the method 700 proceeds to block 724.

At block 724, the processor(s) 302 return to the fully-connected layer 618b to identify the numeric representation with the highest-ranked likelihood or certainty value and that corresponds with the major classification group identified by the fully-connected layer 618a. For example, if the numeric representation output by the fully-connected layer 618a is “13” or “13-0000,” the processor(s) 302 return to the fully-connected layer 618b to identify which numeric representation that corresponds with a major classification group of “13” or “13-0000” has the highest-ranked likelihood or certainty value (e.g., “13-2052”). Upon completing block 724, the method proceeds to block 726.

At block 726, the processor(s) 302 retrieve a standardized occupation classification from the title database 210 based on the identified numeric representation identified. For example, if the processor(s) 302 determine that the numeric representation is “13-2052,” the standardized occupation classification 510 of “Personal Financial Advisors.” At block 728, the processor(s) 302 store the standardized occupation classification and/or the corresponding numeric representation with the employment posting 400 in the posting database 212 to facilitate subsequent employment posting recommendations to a potential candidate (e.g., the candidate 104 of FIG. 1).

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A system for automatically classifying employment titles of employment postings, the system comprising:
memory configured to store a convolutional neural network (CNN) that includes a character-title partial-CNN, a word-title partial-CNN, a description CNN, and at least one fully-connected layer;
one or more processors configured to:
collect an employment posting;
extract text of the employment posting;
identify a title and a description within the extracted text;
apply the character-title partial-CNN to the title to generate a character-level feature based on characters within the title;
apply the word-title partial-CNN to the title to generate a first word-level feature based on words within the title;
apply the description partial-CNN to the description to generate a second word-level feature based on word within the description;
generate a posting feature by concatenating the character-level feature, the first word-level feature, and the second word-level feature; and
determine a numeric representation of a classification for the title by applying the at least one fully-connected layer to the posting feature; and
a posting database in which the one or more processors are configured to store the employment posting and the numeric representation of the title.

2. The system of claim 1, wherein each of the character-title partial-CNN, the word-title partial-CNN, and the description CNN includes a series of convolutional layers and pooling layers.

3. The system of claim 1, wherein the one or more processors are configured to generate the character-level feature by collecting an output of a last layer of the character-title partial-CNN.

4. The system of claim 1, wherein the one or more processors are configured to generate the first word-level feature by concatenating outputs of a plurality of layers of the word-title partial-CNN.

5. The system of claim 1, wherein the one or more processors are configured to generate the second word-level feature by concatenating outputs of a plurality of layers of the description partial-CNN.

6. The system of claim 1, wherein, prior to applying the at least one fully-connected layer to the posting feature, the one or more processors are configured to apply a dropout layer to the posting feature to randomize the posting feature for the at least one fully-connected layer.

7. The system of claim 1, wherein the numeric representation of the classification for the title includes representations of a major classification group, a minor classification group, a broad classification, and a detailed classification.

8. The system of claim 1, wherein the at least one fully-connected layer includes parallel fully-connected layers, wherein the one or more processors are configured to compare outputs of the parallel fully-connected layers to determine the numeric representation of the classification for the title.

9. The system of claim 8, wherein the parallel fully-connected layers include a major fully-connected layer, wherein the one or more processors are configured to generate a second numeric representation by applying the major fully-connected layer to the posting feature, wherein the second numeric representation represents a major classification group.

10. The system of claim 9, wherein the parallel fully-connected layers include a detailed fully-connected layer, wherein the one or more processors are configured to generate a third numeric representation by applying the detailed fully-connected layer to the posting feature, wherein the third numeric representation includes representations of a major classification group, a minor classification group, a broad classification, and a detailed classification.

11. The system of claim 10, wherein, in response to determining that the second numeric representation matches the representation of the major classification group of the third numeric representation, the one or more processors are configured to set the third numeric representation as the numeric representation of the classification for the title.

12. The system of claim 10, wherein, in response to determining that the second numeric representation does not match the representation of the major classification group of the third numeric representation, the one or more processors are configured to:
identify, based on the detailed fully-connected layer, a highest-ranked numeric representation that includes a representation of a major classification group that matches the second numeric representation; and
set the highest-ranked numeric representation as the numeric representation of the classification for the title.

13. The system of claim 1, wherein the one or more processors are configured to determine the numeric representation of the classification for the title in real-time upon collecting the employment posting from a recruiter via an employment website or app.

14. The system of claim 1, further including a candidate database, wherein, in real-time, the one or more processors are configured to match the employment posting with one or more candidate profiles retrieved from the candidate database based on the numeric representation of the classification for the title.

15. The system of claim 1, wherein the one or more processors are configured to:
collect candidate information from a candidate via an employment website or app;
identify the numeric representation of the classification as corresponding with the candidate based on the candidate information;
retrieve the employment posting from the posting database based on the numeric representation; and
recommend, in real-time, the employment posting to the candidate via the employment website or app.

16. A method for automatically classifying employment titles of employment postings, the method comprising:
collecting, via one or more processors, an employment posting;
extracting, via the one or more processors, text of the employment posting;
identifying, via the one or more processors, a title and a description within the extracted text;
applying a character-title partial-CNN of a convolutional neural network (CNN) to the title to generate a character-level feature based on characters within the title;
applying a word-title partial-CNN of the CNN to the title to generate a first word-level feature based on words within the title;
applying a description partial-CNN of the CNN to the description to generate a second word-level feature based on word within the description;
generating a posting feature by concatenating the character-level feature, the first word-level feature, and the second word-level feature;
determining a numeric representation of a classification for the title by applying at least one fully-connected layer of the CNN to the posting feature; and
storing the employment posting and the numeric representation of the title in a posting database.

17. The method of claim 16, wherein applying the at least one fully-connected layer to the posting feature includes:
applying a major fully-connected layer to the posting feature to generate a second numeric representation that represents a major classification group;
applying a detailed fully-connected layer to the posting feature to generate a third numeric representation, wherein the third numeric representation includes representations of a major classification group, a minor classification group, a broad classification, and a detailed classification; and
comparing the second and third numeric representations.

18. The method of claim 17, further including, in response to determining that the second and third numeric representations correspond with each other, setting the third numeric representation as the numeric representation of the classification for the title.

19. The method of claim 17, further including, in response to determining the second and third numeric representations do not correspond with each other:
identifying, based on the detailed fully-connected layer, a highest-ranked numeric representation that includes a representation of a major classification group that matches the second numeric representation; and
setting the highest-ranked numeric representation as the numeric representation of the classification for the title.

20. A tangible computer readable medium including instructions which, when executed, cause a machine to automatically classify employment titles of employment postings by causing the machine to:
collect an employment posting;
extract text of the employment posting;
identify a title and a description within the extracted text;
apply a character-title partial-CNN of a convolutional neural network (CNN) to the title to generate a character-level feature based on characters within the title;
apply a word-title partial-CNN of the CNN to the title to generate a first word-level feature based on words within the title;
apply a description partial-CNN of the CNN to the description to generate a second word-level feature based on word within the description;
generate a posting feature by concatenating the character-level feature, the first word-level feature, and the second word-level feature;
determine a numeric representation of a classification for the title by applying at least one fully-connected layer of the CNN to the posting feature; and
store the employment posting and the numeric representation of the title in a posting database.
